(19) United States
(12) Patent Application Publication
(10) Pub. No.: US 2022/0016927 A1
(43) Pub. Date: Jan. 20, 2022

(54) COVER ASSEMBLY FOR WHEEL HUB

(71) Applicant: Chih-Hsien Liao, Taichung City (TW)

(72) Inventor: Chih-Hsien Liao, Taichung City (TW)

(21) Appl. No.: 17/377,154

(22) Filed: Jul. 15, 2021

(30) Foreign Application Priority Data
Jul. 17, 2020 (TW) 109124283

(51) Int. Cl. B60B 7/00; B60B 7/14; B60B 7/06; B60B 7/04; B60B 7/12

(52) U.S. Cl. CPC B60B 7/0013; B60B 7/14; B60B 7/12; B60B 7/04; B60B 7/066

(57) ABSTRACT

A cover assembly for removably covering a hub of a wheel rim includes a ring-shaped outer cover defining a cover central hole, and a connector having a connector outer annular wall, a connector inner annular wall extending through the cover central hole for connection with a hub inner peripheral wall of the hub and provided with a first external thread for threadedly connecting with a first internal thread of the hub, and an annular flange extending from a junction of the connector inner and outer annular walls. A first elastic ring is sleeved on the connector inner annular wall and is configured to be disposed between and abut against the connector inner annular wall and the hub inner peripheral wall.

### CROSS-REFERENCE TO RELATED APPLICATION

This application claims priority to Taiwanese Patent Application No. 109124283, filed on Jul. 17, 2020.

### FIELD

The disclosure relates to a cover assembly, more particularly to a cover assembly for a hub of a wheel rim.

### BACKGROUND

An existing cover assembly for a hub of a wheel rim, as disclosed in Taiwanese Publication No. 202010654, includes a main cover body and a side cover body. A plurality of first ears is provided in a central hole of the hub. The main cover body has a plurality of second ears provided in a central hole thereof and corresponding to the first ears. A plurality of screws are used to fixedly fasten the second ears to the first ears. The side cover body has a plurality of engaging feet extending outwardly therefrom, and an elastic ring disposed in positioning grooves of the engaging feet. The side cover body covers the central hole of the main cover body by engaging the engaging feet to an annular recess at the back of the central hole of the main cover body.

Although the existing cover assembly can cover the central hole of the hub, because only the engaging feet of the side cover body are engaged to the main cover body, it is likely that the side cover body may be easily detached from the main cover body when the engaging feet are broken, so that dust and moisture can easily enter the hub. Further, since a plurality of the screws are needed to fixedly fasten the main cover body to the hub, assembly and disassembly of the existing cover assembly to the hub are inconvenient.

### SUMMARY

Therefore, an object of the present disclosure is to provide an improved cover assembly that can be easily assembled to and disassembled from a hub of a wheel rim and that can effectively prevent dust and moisture from entering the hub.

According to this disclosure, a cover assembly is configured for removably covering a hub of a wheel rim. The hub includes a hub inner peripheral wall defining a hub central hole and having a first internal thread, a hub outer peripheral wall spaced apart from the hub inner peripheral wall, and a radial peripheral wall connected between the hub inner and outer peripheral walls and that is formed with a plurality of bolt holes surrounding the hub central hole. The cover assembly comprises a ring-shaped outer cover, a connector and a first elastic ring. The outer cover defines a cover central hole and configured to cover the bolt holes. The connector includes a connector outer annular wall, a connector inner annular wall connected to and extending inwardly from the connector outer annular wall, and an annular flange extending outwardly and radially from a junction of the connector inner and outer annular walls. The connector inner annular wall extends through the cover central hole for connection with the hub inner peripheral wall, and has an outer wall surface provided with a first external thread for threadedly connecting with the first internal thread. The annular flange abuts against the outer cover at a side opposite to the bolt holes. The first elastic ring is sleeved on the connector inner annular wall and is configured to be disposed between and abut against the connector inner annular wall and the hub inner peripheral wall.

### BRIEF DESCRIPTION OF THE DRAWINGS

Other features and advantages of the disclosure will become apparent in the following detailed description of the embodiment with reference to the accompanying drawings, of which:

FIG. 1 is an assembled perspective view of a cover assembly according to an embodiment of the present disclosure and a hub of a wheel rim;

FIG. 2 is an exploded perspective view of the embodiment and the hub;

FIG. 3 is an assembled sectional view of the embodiment and the hub; and

FIG. 4 is an enlarged partial sectional view of FIG. 3.

### DETAILED DESCRIPTION

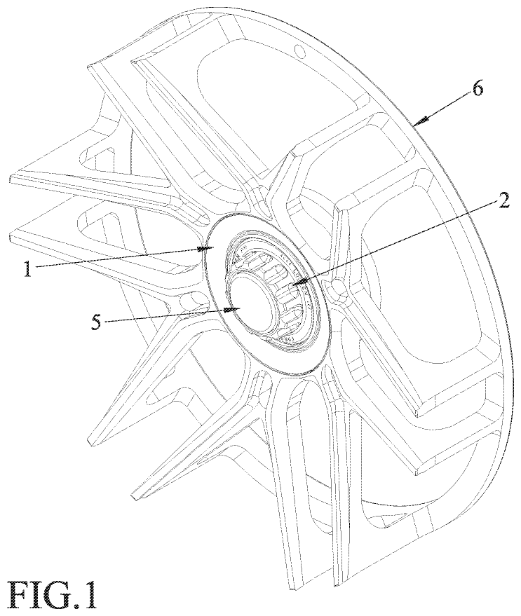

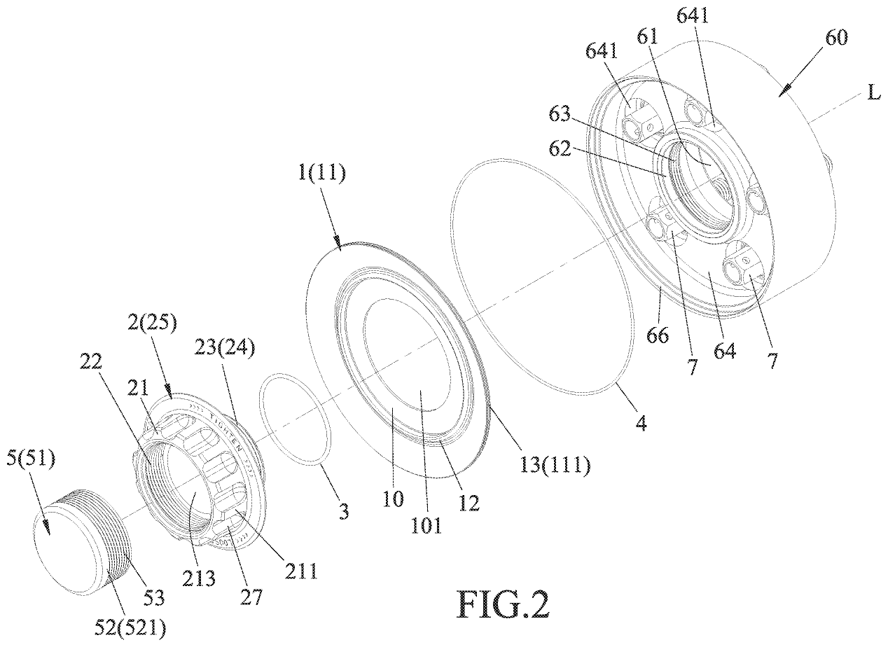

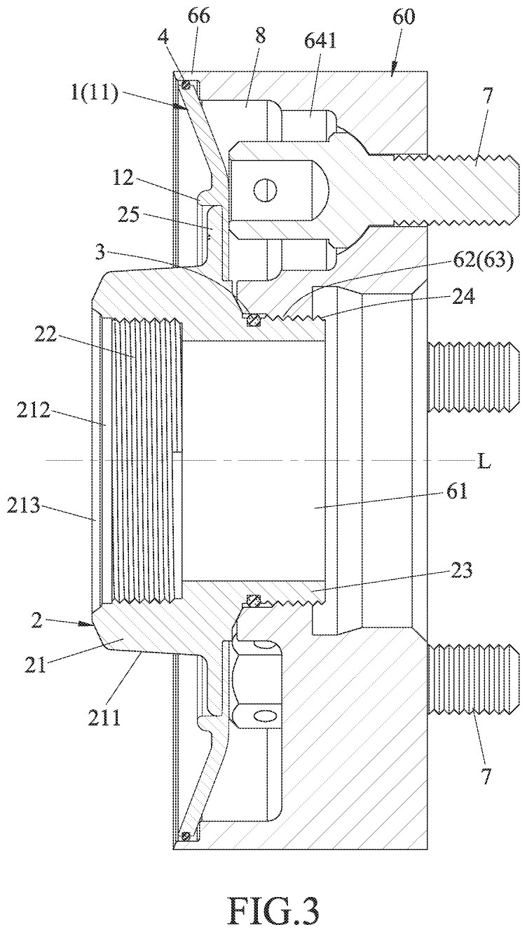

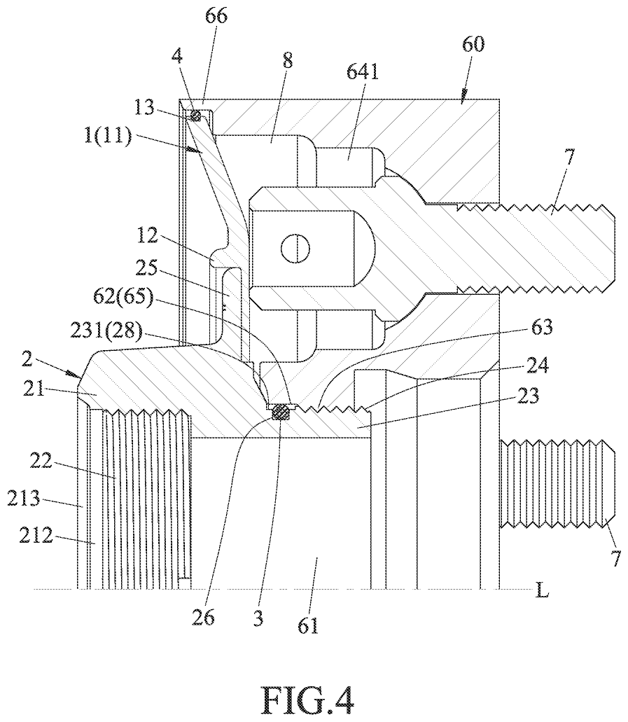

Referring to FIGS. 1 to 4, a cover assembly according to an embodiment of the present disclosure includes a ring-shaped outer cover 1, a connector 2, a first elastic ring 3, a second elastic ring 4 and a decorative cover 5. The cover assembly of this embodiment is configured to removably cover a hub 60 of a wheel rim 6. The hub 60 includes a hub inner peripheral wall 62, a hub outer peripheral wall 66 spaced apart from the hub inner peripheral wall 62, and a radial peripheral wall 64 connected between the hub inner and outer peripheral walls 62, 66. The hub inner peripheral wall 62 surrounds an axis (L), defines a hub central hole 61, and has a first internal thread 63, and a non-threaded portion 65 located externally of the first internal thread 63. The radial peripheral wall 64 is formed with five angularly spaced-apart bolt holes 641 surrounding the hub central hole 61. The hub 60 is connected to an axle (not shown) of a vehicle by extending five bolts 7 respectively through the bolt holes 641.

The ring-shaped outer cover 1 includes a central plate portion 10 surrounding the axis (L) and defining a cover central hole 101, an outer plate portion 11 extending obliquely outward from the central plate portion 10 and configured to cover the bolt holes 641, and an annular protrusion 12 extending outwardly and axially from a junction of the central plate portion 10 and the outer plate portion 11. The outer plate portion 11 has an outer peripheral surface 111 formed with an annular groove 13.

The connector 2 includes a connector outer annular wall 21 surrounding the axis (L) and defining an opening 213, a connector inner annular wall 23 connected to and extending inwardly from the connector outer annular wall 21, and an annular flange 25 extending outwardly and radially from a junction of the connector inner and outer annular walls 23, 21. The connector outer annular wall 21 has an outer wall surface 211 formed with a plurality of angularly spaced-apart concave grip portions 27, and an inner wall surface 212 formed with a second internal thread 22. The opening 213 is opposite to the connector inner annular wall 23 along the axis (L).

The connector inner annular wall 23 extends through the cover central hole 101 to connect with the hub inner peripheral wall 62, and has an outer wall surface 231 provided with a first external thread 24 for threadedly connecting with the first internal thread 63. The outer wall surface 231 is further provided with a non-threaded portion 28 located between the first external thread 24 and the junction of the connector inner and outer annular walls 23, 21, and an annular groove 26 formed in the non-threaded portion 28. The annular flange 25 abuts against the central plate portion 10 at a side opposite to the bolt holes 641, is surrounded by the annular protrusion 12, and has an outer peripheral surface abutting against an inner peripheral surface of the annular protrusion 12.

The annular flange 25 has a thickness in an axial direction smaller than a length of the annular protrusion 12 protruding from the junction of the central plate portion 10 and the outer plate portion 11. The concave grip portions 27 facilitate a user to grip the connector 2 and rotate the same with less effort.

The first elastic ring 3 is sleeved on the connector inner annular wall 23. Specifically, the first elastic ring 3 is received in the annular groove 26, and is disposed between and abuts against a groove-defining wall of the annular groove 26 and the non-threaded portion 65 of the hub inner peripheral wall 62.

The second elastic ring 4 is disposed in the annular groove 13 of the outer plate portion 11, and is configured to be disposed between and abuts against a groove-defining wall of the annular groove 13 and the hub outer peripheral wall 66.

The decorative cover 5 removably covers the opening 213 in the connector outer annular wall 21, and includes a base wall 51 covering the opening 213, and a surrounding wall 52 connected to and extending transversely from a periphery of the base wall 51. The surrounding wall 52 has an outer wall surface 521 formed with a second external thread 53 threadedly connected to the second internal thread 22.

When the cover assembly of this embodiment is assembled to the hub 60, the outer plate portion 11 of the outer cover 1 abuts against the hub 60 and covers the bolt holes 641, the second elastic ring 4 abuts between the groove-defining wall of the annular groove 13 and the hub outer peripheral wall 66, the first external thread 24 is threadedly connected to the first internal thread 63, the first elastic ring 3 abuts between the groove-defining wall of the annular groove 26 and the non-threaded portion 65 of the hub inner peripheral wall 62, the annular flange 25 abuts against the central plate portion 10, and the annular protrusion 12 surrounds the annular flange 25. Further, the outer cover 1, the connector 2 and the hub 60 cooperatively define an internal space 8 communicating with the bolt holes 641.

In this embodiment, with the outer peripheral surface of the annular flange 25 abutting against the inner peripheral surface of the annular protrusion 12, external dust and moisture can be effectively prevented from entering the internal space 8 through an abutment junction of the annular flange 25 and the central plate portion 10.

The advantages of this disclosure can be summarized as follows:

1. Through the threaded connection of the first external thread 24 of the connector inner annular wall 23 with the first internal thread 63 of the hub 60, and through the first elastic ring 3 abutting against the groove-defining wall of the annular groove 26 and the non-threaded portion 65 of the hub inner peripheral wall 62, dust or moisture in the hub central hole 61 can be prevented from entering the internal space 8 along the hub inner peripheral wall 62.

2. The annular protrusion 12 surrounding the annular flange 25 can block part of the dust or moisture from the outside or an outer edge of the hub 60 from entering an abutment junction of the annular flange 25 and the central plate portion 10.

3. Through the abutment of the outer cover 1 against the hub 60, and through the abutment of the second elastic ring 4 between the groove-defining wall of the annular groove 13 and the hub outer peripheral wall 66, entry of dust or moisture from the outside to the internal space 8 through an abutment junction of the outer cover 1 and the hub 60 can be reduced.

4. Through the connector outer annular wall 21 that protrudes outwardly relative to the hub 60 and that is formed with the concave grip portions 27, the user can grip the concave grip portions 27 to rotate the connector 2 with less effort, so that the connector 2 can be conveniently and quickly assembled to and disassembled from the hub 60 without tools.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A cover assembly for removably covering a hub of a wheel rim, the hub including a hub inner peripheral wall that defines a hub central hole and that has a first internal thread, a hub outer peripheral wall spaced apart from the hub inner peripheral wall, and a radial peripheral wall that is connected between the hub inner peripheral wall and the hub outer peripheral wall and that is formed with a plurality of bolt holes surrounding the hub central hole, said cover assembly comprising:
a ring-shaped outer cover defining a cover central hole and configured to cover the bolt holes;
a connector including a connector outer annular wall, a connector inner annular wall connected to and extending inwardly from said connector outer annular wall, and an annular flange extending outwardly and radially from a junction of said connector inner annular wall and said connector outer annular wall, said connector inner annular wall extending through said cover central hole for connection with the hub inner peripheral wall, and having an outer wall surface provided with a first external thread for threadedly connecting with the first internal thread, said annular flange abutting against said ring-shaped outer cover at a side opposite to the bolt holes; and
a first elastic ring sleeved on said connector inner annular wall and configured to be disposed between and abut against said connector inner annular wall and the hub inner peripheral wall.

2. The cover assembly as claimed in claim 1, wherein said outer wall surface of said connector inner annular wall is further provided with an annular groove for receiving said first elastic ring, said first elastic ring being configured to be disposed between and abut against a groove-defining wall of said annular groove and the hub inner peripheral wall.

3. The cover assembly as claimed in claim 2, wherein the hub inner peripheral wall further has a non-threaded portion located externally of the first internal thread, said outer wall surface of said connector inner annular wall being further provided with a non-threaded portion located between said first external thread and said junction of said connector inner annular wall and said connector outer annular wall, said annular groove being formed in said non-threaded portion of said connector inner annular wall and being configured to be disposed between and abut against said groove-defining wall of said annular groove and the non-threaded portion of the hub inner peripheral wall.

4. The cover assembly as claimed in claim 1, wherein said ring-shaped outer cover includes a central plate portion that defines said cover central hole, an outer plate portion extending obliquely outward from said central plate portion, and an annular protrusion that extends outwardly and axially from a junction of said central plate portion and said outer plate portion and that surrounds said annular flange.

5. The cover assembly as claimed in claim 4, wherein said annular flange has a thickness in an axial direction smaller than a length of said annular protrusion protruding from said junction of said central plate portion and said outer plate portion, said annular flange having an outer peripheral surface abutting against an inner peripheral surface of said annular protrusion.

6. The cover assembly as claimed in claim 1, wherein said connector outer annular wall has an outer wall surface formed with at least one concave grip portion.

7. The cover assembly as claimed in claim 1, wherein said connector outer annular wall defines an opening opposite to said connector inner annular wall, and said cover assembly further comprises a decorative cover removably covering said opening.

8. The cover assembly as claimed in claim 7, wherein said connector outer annular wall has an inner wall surface formed with a second internal thread, said decorative cover including a base wall covering said opening, and a surrounding wall connected to and extending transversely from a periphery of said base wall, said surrounding wall having an outer wall surface formed with a second external thread threadedly connected to said second internal thread.

9. The cover assembly as claimed in claim 4, wherein said outer plate portion has an outer peripheral surface formed with an annular groove, said cover assembly further comprising a second elastic ring disposed in said annular groove of said outer plate portion and configured to be disposed between and abut against a groove-defining wall of said annular groove of said outer plate portion and the hub outer peripheral wall of the hub.
